(19) United States
(12) Patent Application Publication
(10) Pub. No.: US 2010/0136366 A1
(43) Pub. Date: Jun. 3, 2010

(54) Tin-coated aluminum material

(75) Inventor: Takaaki Sasaoka, Tsuchiura (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/591,543

(22) Filed: Nov. 23, 2009

(30) Foreign Application Priority Data
Dec. 1, 2008 (JP) 2008-305817

(51) Int. Cl. B32B 15/04; B05D 5/12

(52) U.S. Cl. 428/632; 428/646; 427/123

(57) ABSTRACT

A tin-coated aluminum material includes a base material including aluminum or aluminum alloy, and an anti-corrosion layer and an electrical contact layer formed on an outer layer of the base material, the electrical contact layer including tin or tin alloy. The anti-corrosion layer includes a metal selected from titanium, chromium and niobium or an alloy including the selected metal as a main component. The tin-coated aluminum material may further include a bonding layer including aluminum or aluminum alloy formed between the base material and the anti-corrosion layer. The tin-coated aluminum material may further include aluminum oxide formed at an interfacial region between the base material and the anti-corrosion layer or between the base material and the bonding layer. The aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

The present application is based on Japanese Patent Application No. 2008-305817 filed on Dec. 1, 2008, the entire contents of which are incorporated herein by reference.

### BACKGROUND OF THE INVENTION

1. Field of the Invention

The invention relates to a surface-treated aluminum material as an electrode material, in more particular, relates to a tin-coated aluminum material excellent in adhesion of tin and aluminum as well as excellent in corrosion resistance.

2. Related Art

As contact materials for a terminal block or a printed-circuit board used for electronic devices, etc., a copper-based material, which composes a conductor, is often used applying tin (Sn) plating. On the other hand, in accordance with development of smaller and lighter electronic devices or raising awareness for recycling, reduction in size and weight or recyclability is strongly required also for wiring parts in recent years. In addition, surface layers of both members to be a contact point need to be formed of homogeneous material at an electrical contact portion, and the surface layer is required to be a Sn layer also when an aluminum material is used as a conductor.

An aluminum material is one of the most promising materials as an electrode material since it is light in weight, excellent in processability and low in electric resistivity. Furthermore, it is cheap and excellent in recyclability. However, aluminum is known as a typical hard plating material (a material that is difficult to form a plating film or to solder) because an oxide film (passive film) is likely to be formed on a surface thereof. In addition, the use of aluminum as an electrode material is restricted since it is an amphoteric metal and is likely to be corroded due to external environment (low in corrosion resistance).

Concerning this, a method has been proposed in which, by forming a metal film having high conductivity and excellent corrosion resistance on a surface of the aluminum material, an Sn layer is formed on the aluminum material without losing features of aluminum as a base material, which are excellent conductivity, processability, lightweight properties and recyclability, etc. JP-A 2006-206945 discloses, e.g., a surface-treated Al plate in which a zinc (Zn) layer is formed on a surface of an aluminum (Al) substrate by displacement plating and a nickel (Ni) layer and a bismuth (Bi) layer, a Ni layer and an indium (In) layer, a Ni layer and a sliver (Ag) layer or a Ni layer and a Sn alloy layer are formed thereon by wet plating.

However, in a conventional aluminum material to which surface treatment is applied (e.g., see JP-A 2006-206945), a protective coating layer is generally formed after pretreatment for removing a passive film formed on the surface of the aluminum material is carried out by “degreasing treatment of the surface of the aluminum base material”, “acid pickling treatment of the surface of the base material” or “desmutting treatment”, etc. As a result, there is an advantage in that it is easy to ensure bondability of the aluminum base material to the protective coating layer, however, since the aluminum itself is a material that a passive film tends to be formed, there is a problem that an extreme caution and significant efforts are required for the pretreatment (i.e., it is likely to be high cost). For example, difficulty in storing the pre-treated aluminum material or short extra time from a pretreatment process to a protective film formation process is included.

### SUMMARY OF THE INVENTION

Therefore, it is an object of the invention to provide a tin-coated aluminum material excellent in adhesion between the tin and aluminum and also excellent in corrosion resistance so as to be preferably available as an electrode material without losing features of aluminum (excellent conductivity, processability, lightweight properties and recyclability, etc.).

(1) According to one embodiment of the invention, a tin-coated aluminum material comprises:

a base material comprising aluminum or aluminum alloy; and

an anti-corrosion layer and an electrical contact layer formed on an outer layer of the base material, the electrical contact layer comprising tin or tin alloy,

wherein the anti-corrosion layer comprises a metal selected from titanium, chromium and niobium or an alloy comprising the selected metal as a main component.

In the above embodiment (1), the following modifications and changes can be made.

(i) The tin-coated aluminum material further comprises a bonding layer comprising aluminum or aluminum alloy formed between the base material and the anti-corrosion layer.

(ii) The tin-coated aluminum material further comprises aluminum oxide formed at an interfacial region between the base material and the anti-corrosion layer or between the base material and the bonding layer, wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

(iii) The bonding layer has an average thickness of not more than 40 nm.

(iv) The bonding layer has a pitting potential of electrochemically nobler than that of the base material.

(v) The anti-corrosion layer has an average thickness of not less than 10 nm and not more than 200 nm.

(vi) The electrical contact layer has an average thickness of not less than 10 nm and not more than 200 nm.

(vii) The electrical contact layer has an average thickness of not less than 0.1 nm and not more than 5 nm, and the tin-coated aluminum material further comprises a coating layer comprising tin or tin alloy and formed on the electrical contact layer.

(viii) A junction of the bonding layer and the anti-corrosion layer and/or of the anti-corrosion layer and the electrical contact layer are made by a metal junction.

(2) According to another embodiment of the invention, a method of manufacturing a tin-coated aluminum material, the tin-coated aluminum material comprising:

a base material comprising aluminum or aluminum alloy;

an anti-corrosion layer and an electrical contact layer formed on an outer layer of the base material, the electrical contact layer comprising tin or tin alloy; and

aluminum oxide formed at an interfacial region between the base material and the anti-corrosion layer, comprises:

continuously forming the anti-corrosion layer and the electrical contact layer on a surface of the base material in this order in a same airtight chamber,

wherein the anti-corrosion layer comprises a metal selected from titanium, chromium and niobium or an alloy comprising the selected metal as a main component, and

wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

(3) According to another embodiment of the invention, a method of manufacturing a tin-coated aluminum material,

the tin-coated aluminum material comprising:

a base material comprising aluminum or aluminum alloy;

an anti-corrosion layer and an electrical contact layer formed on an outer layer of the base material, the electrical contact layer comprising tin or tin alloy;

a bonding layer comprising aluminum or aluminum alloy formed between the base material and the anti-corrosion layer; and

aluminum oxide formed at an interfacial region between the base material and the bonding layer, comprises:

continuously forming the bonding layer, the anti-corrosion layer and the electrical contact layer on a surface of the base material in this order in a same airtight chamber,

wherein the anti-corrosion layer comprises a metal selected from titanium, chromium and niobium or an alloy comprising the selected metal as a main component, and

wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

Points of the Invention

According to one embodiment of the invention, a tin-coated aluminum material is constructed such that aluminum oxide is formed (remains) in a predetermined residual amount (abundance ratio) at an interfacial region between a base material and an anti-corrosion layer or a bonding layer. Thus, the tin-coated aluminum material can be rendered excellent in adhesion between a base material (of aluminum) and a coating layer (of tin) and also excellent in corrosion resistance.

### BRIEF DESCRIPTION OF THE DRAWINGS

Next, the present invention will be explained in more detail in conjunction with appended drawings, wherein:

FIG. 1 is a cross sectional schematic view showing an example of a tin-coated aluminum material in a preferred embodiment of the invention; and

FIG. 2 is a cross sectional schematic view showing another example of a tin-coated aluminum material in the embodiment of the invention.

### DESCRIPTION OF THE PREFERRED EMBODIMENTS

The embodiment of the invention will be explained as follows in conjunction with the drawings. It should be noted that the invention is not limited to the embodiment described here, and appropriate combinations and modifications can be implemented without changing the gist of the invention. In addition, aluminum or aluminum alloy may be collectively called “aluminum” and tin or tin alloy may be collectively called “tin”.

Structure of Corrosion-Resistant Aluminum Material

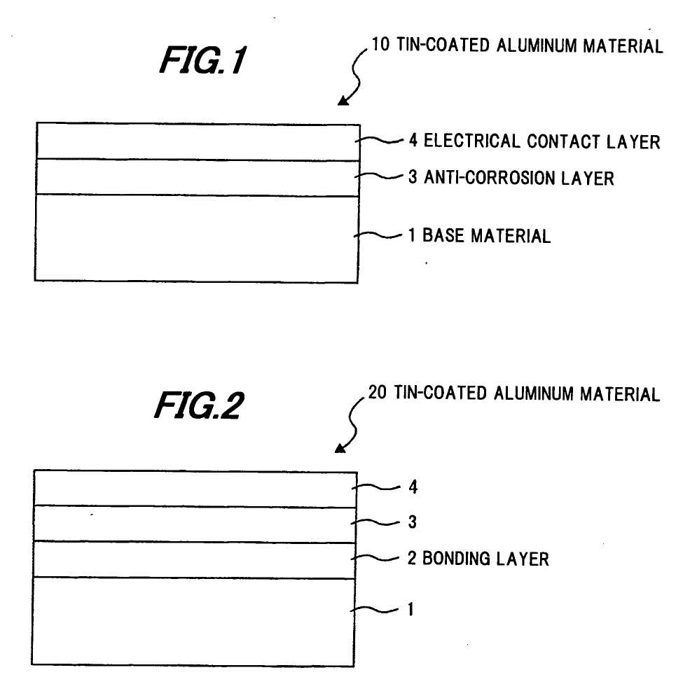

FIG. 1 is a cross sectional schematic view showing an example of a tin-coated aluminum material in an embodiment of the invention. In a tin-coated aluminum material 10, an anti-corrosion layer 3 is formed on a surface of a base material 1 formed of aluminum or aluminum alloy and an electrical contact layer 4 formed of tin or tin alloy is formed on an outer layer of the anti-corrosion layer 3. In FIG. 1, although the anti-corrosion layer 3 and the electrical contact layer 4 are formed on only one side of the base material 1, it is obviously preferable to form on both sides of the base material 1.

FIG. 2 is a cross sectional schematic view showing another example of a tin-coated aluminum material in the embodiment of the invention. In a tin-coated aluminum material 20, an anti-corrosion layer 3 is formed on a surface of a base material 1 formed of aluminum or aluminum alloy via a bonding layer 2 formed of aluminum or aluminum alloy and an electrical contact layer 4 formed of tin or tin alloy is formed on an outer layer of the anti-corrosion layer 3. In FIG. 2, although the bonding layer 2, the anti-corrosion layer 3 and the electrical contact layer 4 are formed on only one side of the base material 1, it is obviously preferable to form on both sides of the base material 1.

As the base material 1, it is possible to use a base material formed of aluminum or aluminum alloy of JIS A1000 series, A2000 series, A3000 series, A5000 series, A6000 series and A7000 series. In addition, a clad material having such aluminum as a surface layer may be used.

The base material 1 is preferably used without removing an oxide layer (e.g., a natural oxide film) or an adsorption layer containing carbon (about several nm in thickness for each) formed in a surface region by pretreatment such as acid pickling treatment (etching treatment), etc. In this regard, however, when the oxide layer is formed 10 nm or more thick or when there is remarkable contamination such as oil, etc., on the surface layer, it is desirable that treatment is applied so as to be less than 10 nm in thickness. Although the treatment is preferably carried out by a dry process in a vacuum (e.g., reverse sputtering treatment, plasma treatment or ion bombardment treatment, etc.), it is not particularly limited as a method of the treatment. The details about a residual amount of the oxide layer (an abundance ratio) will be described later.

Similarly to the base material 1, the bonding layer 2 is formed of aluminum or aluminum alloy of JIS A1000 series, A2000 series, A3000 series, A5000 series, A6000 series and A7000 series. The average thickness of the bonding layer 2 is desirably 40 nm or less. When the average thickness is more than 40 nm, the adhesion force is saturated and there is a disadvantage in that the production cost increases by the increased thickness. Although the bonding layer 2 does not necessarily exist in the tin-coated aluminum material of the invention as shown in FIG. 1, it is preferable that the bonding layer 2 is formed from a viewpoint of durability of the joint of the base material 1 and the anti-corrosion layer 3.

It is preferable that the bonding layer 2 is electrochemically equivalent to or nobler than pitting potential of the base material 1. The durability as a bonding layer is thereby improved. This is for the reason that the bonding layer 2 does not become a sacrificial corrosion layer, i.e., that the bonding layer 2 is not eluted. In general, this layer is a sacrificial corrosion layer in a surface treatment structure of aluminum (a material electrochemically base is selected for the sacrificial corrosion layer), however, the invention is largely different from a prior art in that this layer is opposite (electrochemically noble) to the sacrificial corrosion layer. In addition, it is desirable that the below-described anti-corrosion layer 3 is formed before a natural oxide film is formed on a crystal grain surface of the bonding layer 2. In other words, it is desirable that a crystal grain of the bonding layer 2 is metallically joined to that of the anti-corrosion layer 3.

As described above, in the invention, since the oxide layer, etc., formed at the surface region of the base material 1 is not removed by pretreatment such as acid pickling treatment (etching treatment), etc., aluminum oxide is formed (remains) at an interfacial region between the base material 1 and the bonding layer 2. A preferable residual amount (abundance ratio) is defined as follows.

A type and an oxidation state of element are measured at the interfacial region between the base material 1 and the anti-corrosion layer 3 or that between the base material 1 and the bonding layer 2 by a quantitative analysis in a depth direction of a sample in X-ray photoelectron spectroscopy (XPS) or Auger electron spectroscopy, thereby calculating the abundance ratio X of aluminum oxide (Al₂O₃) which is defined by the following formula.

X=[Al₂O₃]/([Al]+[O]+[principal component of anti-corrosion layer]+[Sn])

At this time, a peak value of X is preferably “0.18≦X≦0.8”. A resolution width in a depth direction in XPS or Auger electron spectroscopy is 2 nm and [ ] in the formula indicates a concentration for the quantitative analysis of which unit is At %.

As understood from the definition, it is shown that the ratio of the aluminum oxide formed at the interfacial region between the base material 1 and the bonding layer 2 is larger as X becomes larger. When “X<0.18”, the corrosion resistance of the tin-coated aluminum material is not good, and when “X>0.18”, contact resistance thereof is not good in case of being used as an electrode material. Therefore, it is determined as “0.18≦X≦0.8”.

As a material of the anti-corrosion layer 3, it is preferable to use one selected from titanium (Ti), chromium (Cr) and niobium (Nb), or an alloy consisting mainly of one selected therefrom. The average thickness of the anti-corrosion layer 3 is desirably not less than 10 nm and not more than 200 nm. There are disadvantages in that a function as an anti-corrosion layer (corrosion resistance) is insufficient when the average thickness is thinner than 10 nm, and that durability tends to decrease and the production cost increases when thicker than 200 nm. The below-described electrical contact layer 4 is desirably formed before a passive film is formed on the crystal grain surface of the anti-corrosion layer 3. In other words, it is desirable that a crystal grain of the anti-corrosion layer 3 is metallically joined to that of the electrical contact layer 4.

The electrical contact layer 4 is formed of tin or tin alloy. When the electrical contact layer 4 is used as a single layer, the average thickness of the electrical contact layer 4 is desirably not less than 10 nm and not more than 200 nm. There are disadvantages in that a function as electrical contact layer (reduction of contact resistance or a degree of adhesion to the base material) is insufficient when the average thickness is thinner than 10 nm, and that the function is saturated and the production cost increases by the increased thickness when thicker than 200 nm.

On the other hand, when a tin-coated layer thicker than 200 nm is required depending on the intended use (e.g., a terminal used for electronic devices, etc.), it is desirable that a coating layer formed of tin or tin alloy is further formed on the electrical contact layer 4 of which average thickness is not less than 0.1 nm and not more than 5 nm. The formation of the coating layer formed of tin or tin alloy is not particularly limited as long as a method suitable for forming a thick film is used (e.g., an electroplating method).

Manufacturing Method of Tin-Coated Aluminum Material

Next, an example of a manufacturing method of a tin-coated aluminum material of the invention will be explained. In the manufacturing method of the tin-coated aluminum material of the invention, since a metal in which a passive film (e.g., a natural oxide film) is likely to be formed on the surface thereof is laminated, it is preferable that Physical Vapor Deposition (e.g., a sputtering method or a vacuum vapor deposition method) using an airtight chamber (so-called vacuum chamber) is used so that an oxide film is not formed on a crystal grain surface of the metal during manufacture.

At first, the base material 1 formed of aluminum or aluminum alloy is prepared. As described above, a pretreatment process of the base material for removing an oxide layer (e.g., a natural oxide film, etc.) formed in a surface region of the base material 1 is not basically carried out. However, when the oxide layer is formed in a thickness of 10 nm or more or when there is remarkable contamination such as oil, etc., on the surface layer, treatment for removing the oxide layer or the contamination may be carried out. The treatment is preferably carried out by a dry process in a vacuum (e.g., reverse sputtering treatment, plasma treatment or ion bombardment treatment, etc.) even though it is not particularly limited as a method of the treatment. In such a case, although the oxide layer in the surface region may be partially removed, the abundance ratio X of aluminum oxide (Al₂O₃) is controlled so as to fall within the above-mentioned predetermined range.

Next, a bonding layer formation process to form the bonding layer 2 on the surface of the base material 1 is carried out by a physical vapor deposition method using a vacuum chamber. By using the physical vapor deposition in which grown grains have high energy, the crystal grain of the bonding layer 2 is directly joined to the base material 1 by partially braking through the oxide layer, etc., formed in a surface region of the base material 1. When the pretreatment process of the base material is carried out, it is preferable that the pretreatment process of the base material and the bonding layer formation process are continuously carried out in the vacuum chamber. Alternatively, as described above, the bonding layer formation process may not be necessarily carried out (see FIG. 1).

Next, an anti-corrosion layer formation process to form the anti-corrosion layer 3 on the surface of the bonding layer 2 is carried out by a physical vapor deposition method using a vacuum chamber. By using the physical vapor deposition in which grown grains have high energy, the crystal grain of the bonding layer 2 is metallically joined to that of the anti-corrosion layer 3 (including partial alloying). In addition, the anti-corrosion layer 3 is desirably formed before a natural oxide film, etc., is formed on the crystal grain surface of the bonding layer 2. In other words, it is desirable that the bonding layer formation process and the anti-corrosion layer formation process are continuously carried out in the vacuum chamber.

When the bonding layer 2 is not formed, an anti-corrosion layer formation process to form the anti-corrosion layer 3 on the surface of the base material 1 is carried out by a physical vapor deposition method using a vacuum chamber. By using the physical vapor deposition in which grown grains have high energy, the crystal grain of the base material 1 is metallically joined to the anti-corrosion layer 3 by partially braking through the oxide layer, etc., formed in the surface region of the base material 1 (including partial alloying). Meanwhile, when the pretreatment process of the base material is carried out, it is preferable that the pretreatment process of the base material and the anti-corrosion layer formation process are continuously carried out in the vacuum chamber.

Next, an electrical contact layer formation process to form the electrical contact layer 4 on the surface of the anti-corrosion layer 3 is carried out by a physical vapor deposition method using a vacuum chamber. By using the physical vapor deposition in which grown grains have high energy, the crystal grain of the anti-corrosion layer 3 is metallically joined to that of the electrical contact layer 4 (including partial alloying). In addition, the electrical contact layer 4 is desirably formed before a natural oxide film, etc., is formed on the crystal grain surface of the anti-corrosion layer 3. In other words, it is desirable that the anti-corrosion layer formation process and the electrical contact layer formation process are continuously carried out in the vacuum chamber. As described above, when a thick tin-coated layer is required depending on the intended use (e.g., a terminal used for electronic devices, etc.), a coating layer formed of tin or tin alloy is formed on the electrical contact layer 4 using a method suitable for forming a thick film (e.g., an electroplating method).

Although the invention will be explained in further detail based on examples as follows, the invention is not limited thereto.

### EXAMPLES

### Conductivity Evaluation of Tin-Coated Aluminum Material

The conductivity evaluation of electrical contact material was conducted, using a plate-like sample material, by respectively measuring contact resistances immediately after manufacturing sample materials (initial stage), after peeling test and after environmental test which are described later. In the measurement method of the contact resistance, a contact resistance value (unit: mf) was evaluated by using a surface coating measuring apparatus (model: SCR-1R) manufactured by Toshin Kogyo Co., Ltd. when a fine gold wire of 0.3 mm in diameter and of 0.5 mm in tip curvature radius is a contact point and the load is 100 gf.

Peeling test: A test, in which a commercially available cellophane adhesive tape (model: CT-18 manufactured by Nichiban Co., Ltd.) is adhered to and peeled from a surface of the sample material, was repeated three times.

Environmental test: A plate-like sample material was dipped in 3.5% NaCl solution (at about 25° C. for 24 hours). Since coating treatment is not applied to the end portion of the sample material and the base material is exposed, it is dipped in the solution after sealing by a vinyl masking tape.

The measurement of the contact resistance immediately after manufacturing the sample material (initial stage) is an evaluation of conductivity which is originally possessed by the sample material, the measurement after the peeling test mentioned below is an evaluation of adhesion and the measurement after the environmental test mentioned below is an evaluation of corrosion resistance. At this time, it is evaluated as sufficient Conductivity, sufficient adhesion and sufficient corrosion resistance when all of the contact resistance values of each measurement are 90 mΩ or less (hereinafter referred to as “applicable”), and it is evaluated as insufficient conductivity, insufficient adhesion or insufficient corrosion resistance when the contact resistance value in any measurement is larger than 90 mΩ (hereinafter referred to as “not applicable”).

XPS Analysis of Tin-Coated Aluminum Material

The aluminum oxide at an interfacial region between the base material and an anti-corrosion layer or between the base material and a bonding layer was analyzed and evaluated for the sample material immediately after manufacturing. An X-ray photoelectron spectrometer with sputter screening (PHI Quantera SXM, manufactured by ULVAC-PHI, INC) was used for the analysis, and abundance ratio X of aluminum oxide was derived by measuring concentration of each element (unit: At %) in a depth direction (thickness direction) of the sample material.

Sample Materials 1-1 to 1-48

A 0.15 nm thick aluminum plate (JIS A1050) was prepared as a base material 1 and was placed in a RF sputtering apparatus (model: SH-350, manufactured by ULVAC, Inc.). Subsequently, a bonding layer 2, an anti-corrosion layer 3 and an electrical contact layer 4 were sequentially formed on the base material 1 by sputtering in the same chamber, thereby manufacturing the tin-coated aluminum materials (sample materials 1-1 to 1-48). Each coating layer (the bonding layer 2, the anti-corrosion layer 3 and the electrical contact layer 4) was formed on both sides of the base material 1. Certain sample materials in which the bonding layer 2 or the anti-corrosion layer 3 is not formed were also manufactured. An aluminum alloy (JIS A5052) was used as the bonding layer 2. Since the pitting potential of JIS A1050 is −753.5 mV (in 2.67% AlCl₃ solution, see Aluminum Handbook 5th edition, p. 66, published by Japan Light Metal Association) and the pitting potential of JIS A5052 is −722.7 mV (in 2.67% AlCl₃ solution, see Aluminum Handbook 5th edition, p. 66, published by Japan Light Metal Association), the pitting potential of the bonding layer 2 is electrochemically nobler than that of the base material 1.

The atmosphere during the film formation was argon (Ar) under pressure of 7 Pa, and the RF output was appropriately adjusted depending on a type of metal to be formed. The thickness of the each layer was controlled by adjusting the film formation time after preliminarily measuring an average film formation rate of each metal species. In the present series (referred to as Example 1 series), the pretreatment process of the base material was not carried out. Table 1 shows components, film thicknesses, surface contact resistance values and XPS analysis results (an abundance ratio of aluminum oxide) of each layer in each sample material.

Sample Materials 2-1 to 2-27

A 0.15 nm thick aluminum plate (JIS A1050) was prepared as a base material 1. At this time, after placing the base material in the RF sputtering apparatus (model: SH-350, manufactured by ULVAC, Inc.), reverse sputtering was initially applied at 500 W of output for 1 minute. After that, each coating layer (the bonding layer 2, the anti-corrosion layer 3 and the electrical contact layer 4) was formed on the both sides of the base material 1 in the same procedure as the above-mentioned Example 1 series, thereby manufacturing the tin-coated aluminum materials (sample materials 2-1 to 2-27). Certain sample materials in which the bonding layer 2 is not formed or in which acid pickling treatment is applied to the base material 1 were also manufactured. The present series is referred to as Example 2 series. Table 2 shows components, film thicknesses, surface contact resistance values and XPS analysis results (an abundance ratio of aluminum oxide) of each layer in each sample material.

Sample Materials 3-1 to 3-7

A 0.15 nm thick aluminum plate (JIS A1050) was prepared as a base material 1. Treatment for forming an oxide film on a surface (an oxide film formation process: dipping in deionized water at 90° C. for 3 minutes or dipping in deionized water at 90° C. for 30 minutes) was applied to the prepared base material. After that, each coating layer (the bonding layer 2, the anti-corrosion layer 3 and the electrical contact layer 4) was formed on the both sides of the base material 1 in the same procedure as the above-mentioned Example 1 series, thereby manufacturing the tin-coated aluminum materials (sample materials 3-1 to 3-7). Certain sample materials in which the bonding layer 2 is not formed were also manufactured. The present series is referred to as Example 3 series. Table 3 shows components, film thicknesses, surface contact resistance values and XPS analysis results (an abundance ratio of aluminum oxide) of each layer in each sample material.

Sample Materials 4-1 to 4-3

A 0.15 nm thick aluminum plate (JIS A6101) was selected as a base material 1 and pure aluminum (IN99-0) was selected as a material of the bonding layer 2. Then, each coating layer (the bonding layer 2, the anti-corrosion layer 3 and the electrical contact layer 4) was formed on the both sides of the base material 1 in the same procedure as the above-mentioned Example 1 series, thereby manufacturing the tin-coated aluminum materials (sample materials 4-1 to 4-3). The present series is referred to as Example 4 series. Table 4 shows components, film thicknesses, surface contact resistance values and XPS analysis results (an abundance ratio of aluminum oxide) of each layer in each sample material. The pitting potential of JIS A6101 is estimated between −704.2 and −742.3 mV (in 2.67% AlCl₃ solution, see Aluminum Handbook 5th edition, p. 66, published by Japan Light Metal Association). On the other hand, since the pitting potential of 1N199-0 of the bonding layer 2 is −751.5 mV, the bonding layer 2 is electrochemically baser than the base material 1.

Sample materials 5-1 to 5-6

A 0.15 nm thick aluminum plate (JIS A1050) was prepared as a base material 1 and each coating layer (the bonding layer 2, the anti-corrosion layer 3 and the electrical contact layer 4) was formed on the both sides of the base material 1 in the same procedure as the above-mentioned Example 1 series. After that, 1 μm thick Sn plating was applied on the electrical contact layer 4 by an electroplating method, thereby manufacturing the tin-coated aluminum materials (sample materials 5-1 to 5-6). Certain sample materials in which the bonding layer 2 is not formed were also manufactured. The present series is referred to as Example 5 series. Table 5 shows components, film thicknesses, surface contact resistance values and XPS analysis results (an abundance ratio of aluminum oxide) of each layer in each sample material.

TABLE 1
Table 1 Structure and evaluation/analysis results of tin-coated
aluminum materials in Example 1 series
(Base material: JIS A1050, bonding layer: JIS A5052)

| | Bonding | Anti-corrosion | | Electrical contact | | Contact resistance (mΩ) | | | |
|---|---|---|---|---|---|---|---|---|---|
| | layer | layer | | layer | | | After | After | Abundance |
| Sample | Thickness | | Thickness | | Thickness | Initial | peeling | environmental | ratio of |
| material | (nm) | Material | (nm) | Material | (nm) | stage | test | test | Al₂O₃ |
| 1-1 | None | Nb | 30 | Sn | 20 | 15 | 17 | 65 | 0.28 |
| 1-2 | 10 | | 30 | | 20 | 16 | 17 | 30 | 0.39 |
| 1-3 | 40 | | 30 | | 20 | 18 | 18 | 25 | 0.38 |
| 1-4 | 10 | | 10 | | 20 | 16 | 16 | 42 | |
| 1-5 | 10 | | 200 | | 20 | 20 | 21 | 23 | |
| 1-6 | 10 | | 30 | | 10 | 25 | 25 | 30 | |
| 1-7 | 10 | | 30 | | 200 | 10 | 20 | 25 | |
| 1-8 | None | Cr | 30 | | 20 | 17 | 19 | 65 | 0.25 |
| 1-9 | 10 | | 30 | | 20 | 18 | 19 | 30 | 0.4 |
| 1-10 | 40 | | 30 | | 20 | 19 | 19 | 24 | |
| 1-11 | 10 | | 10 | | 20 | 18 | 18 | 43 | |
| 1-12 | 10 | | 200 | | 20 | 22 | 23 | 24 | |
| 1-13 | 10 | | 30 | | 10 | 30 | 30 | 31 | |
| 1-14 | 10 | | 30 | | 200 | 11 | 21 | 24 | |
| 1-15 | None | Ti | 30 | | 20 | 13 | 15 | 70 | |
| 1-16 | 10 | | 30 | | 20 | 14 | 15 | 35 | |
| 1-17 | 40 | | 30 | | 20 | 16 | 16 | 30 | |
| 1-18 | 10 | | 10 | | 20 | 14 | 15 | 40 | |
| 1-19 | 10 | | 200 | | 20 | 18 | 19 | 25 | |
| 1-20 | 10 | | 30 | | 10 | 20 | 20 | 40 | |
| 1-21 | 10 | | 30 | | 200 | 12 | 13 | 29 | |
| 1-22 | 10 | Ti—0.2Pd | 30 | | 20 | 14 | 15 | 28 | |
| 1-23 | 10 | Ti—20Nb | 30 | | 20 | 16 | 16 | 27 | |
| 1-24 | 10 | Ti | 30 | Sn—6Cu | 20 | 13 | 15 | 40 | |
| 1-25 | 10 | Cr | 30 | | 20 | 16 | 16 | 32 | |
| 1-26 | 10 | Nb | 30 | | 20 | 17 | 18 | 26 | |
| 1-27 | 10 | Ti | 30 | Sn—5Ag | 20 | 13 | 15 | 38 | |
| 1-28 | 10 | Cr | 30 | | 20 | 16 | 16 | 31 | |
| 1-29 | 10 | Nb | 30 | | 20 | 17 | 17 | 25 | |
| 1-30 | 10 | Ti | 30 | Sn—6Zn | 20 | 14 | 16 | 33 | |
| 1-31 | 10 | Cr | 30 | | 20 | 18 | 18 | 31 | |
| 1-32 | 10 | Nb | 30 | | 20 | 17 | 18 | 24 | |
| 1-33 | 10 | Ti | 30 | Sn—6Bi | 20 | 13 | 15 | 40 | |
| 1-34 | 10 | Cr | 30 | | 20 | 16 | 16 | 32 | |
| 1-35 | 10 | Nb | 30 | | 20 | 17 | 18 | 26 | |
| 1-36 | 10 | Ti | 30 | Sn—6Pb | 20 | 12 | 12 | 44 | |
| 1-37 | 10 | Cr | 30 | | 20 | 13 | 14 | 40 | |
| 1-38 | 10 | Nb | 30 | | 20 | 19 | 19 | 33 | |
| 1-39 | 10 | Ti | 30 | Sn—1Au | 20 | 10 | 10 | 25 | |
| 1-40 | 10 | Cr | 30 | | 20 | 11 | 11 | 30 | |
| 1-41 | 10 | Nb | 30 | | 20 | 11 | 11 | 30 | |
| 1-42 | None | None | | Sn | 20 | 40 | 40 | 200 | |
| 1-43 | 10 | None | | | 20 | 30 | 35 | 200 | |
| 1-44 | 10 | Nb | 8 | | 20 | 40 | 90 | 150 | |
| 1-45 | 10 | Nb | 30 | | 5 | 100 | 100 | 110 | |
| 1-46 | 50 | Nb | 30 | | 20 | 30 | 50 | 100 | |
| 1-47 | 10 | Nb | 250 | | 20 | 95 | 100 | 120 | |
| 1-48 | 10 | Nb | 30 | | 220 | 10 | 40 | 120 | |

Notes:
in the column of “material”, the number before chemical symbol denotes “mass %” of additional element.

TABLE 2
Table 2 Structure and evaluation/analysis results of tin-coated
aluminum materials in Example 2 series
(Base material: JIS A1050, bonding layer: JIS A5052, pretreatment
process of base material: applied)

| | Bonding | Anti-corrosion | | Electrical contact | | Contact resistance (mΩ) | | | |
|---|---|---|---|---|---|---|---|---|---|
| | layer | layer | | layer | | | After | After | Abundance |
| Sample | Thickness | | Thickness | | Thickness | Initial | peeling | environmental | ratio of |
| material | (nm) | Material | (nm) | Material | (nm) | stage | test | test | Al₂O₃ |
| 2-1 | None | Nb | 30 | Sn | 20 | 12 | 12 | 65 | 0.18 |
| 2-2 | 10 | | 30 | | 20 | 12 | 13 | 40 | 0.22 |
| 2-3 | None | Cr | 30 | | 20 | 13 | 13 | 70 | |
| 2-4 | 10 | | 30 | | 20 | 13 | 13 | 35 | |
| 2-5 | None | Ti | 30 | | 20 | 11 | 11 | 80 | |
| 2-6 | 10 | | 30 | | 20 | 11 | 11 | 40 | |
| 2-7 | 10 | Ti—0.2Pd | 30 | | 20 | 12 | 12 | 35 | |
| 2-8 | 10 | Ti—20Nb | 30 | | 20 | 12 | 12 | 33 | |
| 2-9 | 10 | Ti | 30 | Sn—6Cu | 20 | 10 | 11 | 44 | |
| 2-10 | 10 | Cr | 30 | | 20 | 12 | 12 | 34 | |
| 2-11 | 10 | Nb | 30 | | 20 | 11 | 11 | 33 | |
| 2-12 | 10 | Ti | 30 | Sn—5Ag | 20 | 10 | 11 | 41 | |
| 2-13 | 10 | Cr | 30 | | 20 | 12 | 12 | 32 | |
| 2-14 | 10 | Nb | 30 | | 20 | 11 | 11 | 31 | |
| 2-15 | 10 | Ti | 30 | Sn—6Zn | 20 | 10 | 12 | 30 | |
| 2-16 | 10 | Cr | 30 | | 20 | 11 | 11 | 33 | |
| 2-17 | 10 | Nb | 30 | | 20 | 11 | 11 | 35 | |
| 2-18 | 10 | Ti | 30 | Sn—6Bi | 20 | 11 | 11 | 42 | |
| 2-19 | 10 | Cr | 30 | | 20 | 12 | 12 | 34 | |
| 2-20 | 10 | Nb | 30 | | 20 | 11 | 11 | 28 | |
| 2-21 | 10 | Ti | 30 | Sn—6Pb | 20 | 11 | 11 | 46 | |
| 2-22 | 10 | Cr | 30 | | 20 | 12 | 12 | 48 | |
| 2-23 | 10 | Nb | 30 | | 20 | 11 | 11 | 45 | |
| 2-24 | 10 | Ti | 30 | Sn—1Au | 20 | 10 | 10 | 29 | |
| 2-25 | 10 | Cr | 30 | | 20 | 10 | 10 | 33 | |
| 2-26 | 10 | Nb | 30 | | 20 | 10 | 10 | 33 | |
| 2-27 | 10 | Nb | 30 | Sn | 20 | 12 | 12 | 120 | 0.12 |

Notes:
in the column of “material”, the number before chemical symbol denotes “mass %” of additional element.

TABLE 3
Table 3 Structure and evaluation/analysis results of tin-coated
aluminum materials in Example 3 series
(Base material: JIS A1050, bonding layer: JIS A5052, oxide film
formation process: applied)

| | Bonding | Anti-corrosion | | Electrical contact | | Contact resistance (mΩ) | | | |
|---|---|---|---|---|---|---|---|---|---|
| | layer | layer | | layer | | | After | After | Abundance |
| Sample | Thickness | | Thickness | | Thickness | Initial | peeling | environmental | ratio of |
| material | (nm) | Material | (nm) | Material | (nm) | stage | test | test | Al₂O₃ |
| 3-1 | None | Nb | 30 | Sn | 20 | 30 | 30 | 70 | 0.65 |
| 3-2 | 10 | | 30 | | 20 | 32 | 33 | 55 | 0.75 |
| 3-3 | None | Cr | 30 | | 20 | 32 | 33 | 74 | |
| 3-4 | 10 | | 30 | | 20 | 30 | 30 | 45 | |
| 3-5 | None | Ti | 30 | | 20 | 29 | 29 | 85 | |
| 3-6 | 10 | | 30 | | 20 | 29 | 29 | 60 | |
| 3-7 | 10 | Nb | 30 | | 20 | 140 | 140 | 180 | 0.85 |

TABLE 4
Table 4 Structure and evaluation/analysis results of tin-coated
aluminum materials in Example 4 series
(Base material: JIS A6101, bonding layer: JIS A1050)

| | Bonding | Anti-corrosion | | Electrical contact | | Contact resistance (mΩ) | | | |
|---|---|---|---|---|---|---|---|---|---|
| | layer | layer | | layer | | | After | After | Abundance |
| Sample | Thickness | | Thickness | | Thickness | Initial | peeling | environmental | ratio of |
| material | (nm) | Material | (nm) | Material | (nm) | stage | test | test | Al₂O₃ |
| 4-1 | 10 | Nb | 30 | Sn | 20 | 30 | 30 | 88 | |
| 4-2 | 10 | Cr | 30 | | 20 | 30 | 30 | 75 | |
| 4-3 | 10 | Ti | 30 | | 20 | 29 | 29 | 85 | |

TABLE 5
Table 5 Structure and evaluation/analysis results of tin-coated
aluminum materials in Example 5 series
(Base material: JIS A1050, bonding layer: JIS A5052, electrolytic
Sn plating: applied)

| | Bonding | Anti-corrosion | | Electrical contact | | | Contact resistance (mΩ) | | |
|---|---|---|---|---|---|---|---|---|---|
| | layer | layer | | layer | | | | After | After |
| Sample | Thickness | | Thickness | | Thickness | Electrolytic | Initial | peeling | environmental |
| material | (nm) | Material | (nm) | Material | (nm) | Sn plating | stage | test | test |
| 5-1 | None | Nb | 30 | Sn | 0.1 | 1 μm | 8 | 9 | 30 |
| 5-2 | | | 30 | | 0.5 | | 8 | 8 | 27 |
| 5-3 | | | 30 | | 5 | | 8 | 8 | 25 |
| 5-4 | 10 | | 30 | | 0.1 | 1 μm | 8 | 9 | 30 |
| 5-5 | | | 30 | | 0.5 | | 8 | 8 | 27 |
| 5-6 | | | 30 | | 5 | | 8 | 8 | 25 |

As shown in the sample materials 1-1 to 1-41 in Example 1 series (see Table 1), when the thickness of the bonding layer is 40 nm or less (including the case of no bonding layer), the bonding layer had good conductivity, adhesion and corrosion resistance and was applicable. In contrast, the sample material 1-46, in which the bonding layer is thicker than the thickness defined in the invention, was inferior in corrosion resistance and was not applicable.

The anti-corrosion layer was applicable when the material was Nb, Cr or Ti having a thickness of 10-200 nm. In contrast, the sample material 1-44, in which the anti-corrosion layer is thinner than the thickness defined in the invention, was inferior in corrosion resistance and was not applicable. In addition, the sample material 1-47, in which the anti-corrosion layer is thicker than the thickness defined in the invention, was inferior in all of conductivity, adhesion and corrosion resistance, and was not applicable. On the other hand, as shown in the sample materials 1-22 and 1-23, it was found that the material of the anti-corrosion layer may be alloyed (Ti-0.2 mass % Pd, Ti-20 mass % Nb).

As shown in the sample materials 1-1 to 1-41, the electrical contact layer was applicable in a thickness range of not less than 10 nm and not more than 200 nm. In contrast, the sample material 1-48, in which the electrical contact layer is thicker than the thickness defined in the invention, was inferior in corrosion resistance and was not applicable. In addition, the sample material 1-45, in which the electrical contact layer is thinner than the thickness defined in the invention, was inferior in all of conductivity, adhesion and corrosion resistance, and was not applicable. Furthermore, as shown in the sample materials 1-42 and 1-43, it was confirmed that the corrosion resistance is greatly decreased also in case of no electrical contact layer. On the other hand, as shown in the sample materials 1-24 to 1-41, it was confirmed that the material of the electrical contact layer is applicable even tin is alloyed.

In Example 2 series, reverse sputtering is performed as a pretreatment process of the base material before forming a bonding layer or an anti-corrosion layer, assuming the case that there is contamination such as oil, etc., on the surface layer of the base material. As shown in Table 2, the sample materials 2-1 to 2-26 which falls within a range defined in the invention had good conductivity, adhesion and corrosion resistance and were applicable. In contrast, the sample material 2-27 is a sample material in which the reverse sputtering is further performed after applying the acid pickling treatment to the base material and the abundance ratio of aluminum oxide is very small at the interfacial region between the base material and the bonding layer. As understood from the result of the conductivity evaluation, it was confirmed that the sample material 2-27 is inferior in corrosion resistance. In other words, the abundance ratio of aluminum oxide at the interfacial region between the base material and an upper layer (a bonding layer or an anti-corrosion layer) is desirably 0.18 or more.

Example 3 series is to examine an upper limit of the abundance ratio of aluminum oxide at the interfacial region between the base material and the anti-corrosion layer or that between the base material and the bonding layer. The sample materials 3-1 to 3-6 are sample materials which are “dipped in deionized water at 90° C. for 3 minutes” as an oxide film formation process, and the sample material 3-7 is a sample material which is “dipped in deionized water at 90° C. for 30 minutes” as an oxide film formation process. As shown in Table 3, it was confirmed that the sample material 3-7 has large contact resistance and is inferior in conductivity. In contrast, the sample materials 3-1 to 3-6 had good conductivity, adhesion and corrosion resistance and were applicable. From Example 3 series, the abundance ratio of aluminum oxide at the interfacial region between the base material and an upper layer (a bonding layer or an anti-corrosion layer) is desirably 0.8 or less.

Example 4 series is to examine the sample materials in which the bonding layer is electrochemically baser than the base material. As shown in Table 4, each sample material had sufficient conductivity, adhesion and corrosion resistance and was applicable. However, from the comparison with the sample materials 1-2, 1-9 and 1-16, it was confirmed that the bonding layer is preferably electrochemically nobler than the base material.

Example 5 series is an example that a coating layer formed of tin or tin alloy is formed thick on the electrical contact layer 4. As understood from the result in Table 5, each sample material had good conductivity and corrosion resistance. From this result, it was confirmed that, when the coating layer formed of tin or tin alloy is further formed on the electrical contact layer 4, even the thickness of about 0.1-5 nm is sufficient for the electrical contact layer 4.

As shown above, it was confirmed that the tin-coated aluminum material of the invention has good conductivity and corrosion resistance. Furthermore, since the coating layer covering the aluminum base material is much thinner than that of the prior art, it is possible to contribute to reduce the cost. Namely, the tin-coated aluminum material of the invention is useful for various electrode materials which require good adhesion of tin to a conductor or excellent corrosion resistance, and the industrial value thereof is high.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A tin-coated aluminum material, comprising:
a base material comprising aluminum or aluminum alloy; and
an anti-corrosion layer and an electrical contact layer formed on an outer layer of the base material, the electrical contact layer comprising tin or tin alloy,
wherein the anti-corrosion layer comprises a metal selected from titanium, chromium and niobium or an alloy comprising the selected metal as a main component.

2. The tin-coated aluminum material according to claim 1, further comprising:
a bonding layer comprising aluminum or aluminum alloy formed between the base material and the anti-corrosion layer.

3. The tin-coated aluminum material according to claim 1, further comprising:
aluminum oxide formed at an interfacial region between the base material and the anti-corrosion layer,
wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

4. The tin-coated aluminum material according to claim 1, wherein
the anti-corrosion layer has an average thickness of not less than 10 nm and not more than 200 nm.

5. The tin-coated aluminum material according to claim 1, wherein
the electrical contact layer has an average thickness of not less than 10 nm and not more than 200 nm.

6. The tin-coated aluminum material according to claim 1, wherein
the electrical contact layer has an average thickness of not less than 0.1 nm and not more than 5 nm, and
the tin-coated aluminum material further comprises a coating layer comprising tin or tin alloy and formed on the electrical contact layer.

7. The tin-coated aluminum material according to claim 1, wherein
a junction of the anti-corrosion layer and the electrical contact layer are made by a metal junction.

8. The tin-coated aluminum material according to claim 2, further comprising:
aluminum oxide formed at an interfacial region between the base material and the bonding layer,
wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

9. The tin-coated aluminum material according to claim 2, wherein
the bonding layer has an average thickness of not more than 40 nm.

10. The tin-coated aluminum material according to claim 2, wherein
the bonding layer has a pitting potential of electrochemically nobler than that of the base material.

11. The tin-coated aluminum material according to claim 2, wherein
the anti-corrosion layer has an average thickness of not less than 10 nm and not more than 200 nm.

12. The tin-coated aluminum material according to claim 2, wherein
the electrical contact layer has an average thickness of not less than 10 nm and not more than 200 nm.

13. The tin-coated aluminum material according to claim 2, wherein
the electrical contact layer has an average thickness of not less than 0.1 nm and not more than 5 nm, and
the tin-coated aluminum material further comprises a coating layer comprising tin or tin alloy and formed on the electrical contact layer.

14. The tin-coated aluminum material according to claim 2, wherein
a junction of the bonding layer and the anti-corrosion layer and/or of the anti-corrosion layer and the electrical contact layer are made by a metal junction.

15. A method of manufacturing a tin-coated aluminum material,
the tin-coated aluminum material comprising:
a base material comprising aluminum or aluminum alloy;
an anti-corrosion layer and an electrical contact layer formed on an outer layer of the base material, the electrical contact layer comprising tin or tin alloy; and
aluminum oxide formed at an interfacial region between the base material and the anti-corrosion layer,
said method comprising:
continuously forming the anti-corrosion layer and the electrical contact layer on a surface of the base material in this order in a same airtight chamber,
wherein the anti-corrosion layer comprises a metal selected from titanium, chromium and niobium or an alloy comprising the selected metal as a main component, and
wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.

16. A method of manufacturing a tin-coated aluminum material,
the tin-coated aluminum material comprising:
a base material comprising aluminum or aluminum alloy;
an anti-corrosion layer and an electrical contact layer formed on an outer layer of the base material, the electrical contact layer comprising tin or tin alloy;
a bonding layer comprising aluminum or aluminum alloy formed between the base material and the anti-corrosion layer; and
aluminum oxide formed at an interfacial region between the base material and the bonding layer,
said method comprising:
continuously forming the bonding layer, the anti-corrosion layer and the electrical contact layer on a surface of the base material in this order in a same airtight chamber,
wherein the anti-corrosion layer comprises a metal selected from titanium, chromium and niobium or an alloy comprising the selected metal as a main component, and
wherein the aluminum oxide at the interfacial region has a peak value of not less than 0.18 and not more than 0.8 in an abundance ratio of aluminum oxide=(aluminum oxide)/(aluminum+oxygen+the main component of the anti-corrosion layer+tin) where a resolution width is 2 nm for a quantitative analysis in a depth direction in an X-ray photoelectron spectroscopy or Auger electron spectroscopy.
